(19) United States
(12) Patent Application Publication
(10) Pub. No.: US 2026/0042005 A1
(43) Pub. Date: Feb. 12, 2026

(54) INTERACTION METHOD FOR VIRTUAL SCENE, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Qingbo YU, Shenzhen (CN); Ya ZHANG, Shenzhen (CN); Xiyang ZHOU, Shenzhen (CN); Jiyuan LI, Shenzhen (CN)

(21) Appl. No.: 19/360,962

(22) Filed: Oct. 16, 2025

Related U.S. Application Data
(63) Continuation of application No. PCT/CN2024/119711, filed on Sep. 19, 2024.

(30) Foreign Application Priority Data
Dec. 5, 2023 (CN) 202311665844.3

(51) Int. Cl. A63F 13/52

(52) U.S. Cl. CPC A63F 13/52

(57) ABSTRACT

An interaction method for a virtual scene performed by an electronic device includes displaying at least one virtual card in a card area of the virtual scene, the virtual card carrying a virtual character and at least one virtual skill associated with the virtual character; controlling, in response to a character control instruction triggered based on a target virtual card, a target virtual character carried in the target virtual card to move to a target position in an interaction area of the virtual scene; and controlling, in response to a skill release instruction triggered based on the target virtual card, the target virtual character to release an associated target virtual skill.

### CROSS-REFERENCES TO RELATED APPLICATION

This application is a continuation application of PCT Patent Application No. PCT/CN2024/119711, filed on Sep. 19, 2024, which claims priority to Chinese Patent Application No. 2023116658443, filed on Dec. 5, 2023, all of which is incorporated herein by reference in their entirety.

### FIELD OF THE TECHNOLOGY

The present disclosure relates to the field of human-computer interaction technologies, and in particular, to an interaction method and apparatus for a virtual scene, a device, a storage medium, and a program product.

### BACKGROUND OF THE DISCLOSURE

A display technology based on graphics processing hardware has expanded channels for perceiving the environment and acquiring information. In particular, display technology of a virtual scene can enable, depending on an actual application requirement, diverse interactions between virtual objects controlled by either users or artificial intelligence. It has various typical application scenarios, such as a virtual game scene in which a realistic battle process between virtual characters can be simulated.

In an example in which the virtual scene is a card game, a player usually possesses a deck of cards, and each card represents a virtual character or a virtual skill. In a gameplay, the player needs to develop a policy by combining and using different cards, to achieve an objective of defeating opponents. However, in this type of game mode, the degree of association between a virtual character and a virtual skill is low, requiring the player to spend significant learning efforts to master card combination strategies, resulting in low interaction efficiency.

### SUMMARY

One embodiment of the present disclosure provides an interaction method for a virtual scene, performed by an electronic device. The method includes displaying at least one virtual card in a card area of the virtual scene, the virtual card carrying a virtual character and at least one virtual skill associated with the virtual character; controlling, in response to a character control instruction triggered based on a target virtual card, a target virtual character carried in the target virtual card to move to a target position in an interaction area of the virtual scene; and controlling, in response to a skill release instruction triggered based on the target virtual card, the target virtual character to release an associated target virtual skill.

Another embodiment of the present disclosure provides an electronic device. The electronic device includes one or more processors and a memory containing a computer-executable instruction or a computer program that, when being executed, causes the one or more processors to perform: displaying at least one virtual card in a card area of the virtual scene, the virtual card carrying a virtual character and at least one virtual skill associated with the virtual character; controlling, in response to a character control instruction triggered based on a target virtual card, a target virtual character carried in the target virtual card to move to a target position in an interaction area of the virtual scene; and controlling, in response to a skill release instruction triggered based on the target virtual card, the target virtual character to release an associated target virtual skill.

Another embodiment of the present disclosure provides a non-transitory computer-readable storage medium containing a computer-executable instruction or a computer program that, when being executed, causes at least one processor to perform: displaying at least one virtual card in a card area of the virtual scene, the virtual card carrying a virtual character and at least one virtual skill associated with the virtual character; controlling, in response to a character control instruction triggered based on a target virtual card, a target virtual character carried in the target virtual card to move to a target position in an interaction area of the virtual scene; and controlling, in response to a skill release instruction triggered based on the target virtual card, the target virtual character to release an associated target virtual skill.

### BRIEF DESCRIPTION OF THE DRAWINGS

FIG. 1 is a schematic diagram of an architecture of an interaction system for a virtual scene in accordance with an embodiment of the present disclosure.

FIG. 2 is a schematic structural diagram of an electronic device in accordance with an embodiment of the present disclosure.

FIG. 3 is a flowchart of an interaction method for a virtual scene in accordance with an embodiment of the present disclosure.

FIG. 4 is a schematic diagram of control of a virtual character in accordance with an embodiment of the present disclosure.

FIG. 5 is a schematic diagram of instruction triggering in accordance with an embodiment of the present disclosure.

FIG. 6 is a schematic diagram of changing of a card type in accordance with an embodiment of the present disclosure.

FIG. 7 is a schematic diagram of skill release in accordance with an embodiment of the present disclosure.

FIG. 8 is a schematic diagram of skill release in accordance with an embodiment of the present disclosure.

FIG. 9 is a flowchart of an interaction method for a virtual scene in accordance with an embodiment of the present disclosure.

FIG. 10 is a schematic diagram of changing of a card type in accordance with an embodiment of the present disclosure.

FIG. 11 is a schematic diagram of a changing method of a card type in accordance with an embodiment of the present disclosure.

FIG. 12 is a schematic diagram of changing of a card type in accordance with an embodiment of the present disclosure.

FIG. 13 is a schematic diagram of changing of a card type in accordance with an embodiment of the present disclosure.

### DESCRIPTION OF EMBODIMENTS

To make objectives, technical solutions, and advantages of the present disclosure clearer, the following further describes the present disclosure in detail with accompanying drawings. The described embodiments do not be construed as limitation on the present disclosure. All other embodiments obtained by a person of ordinary skill in the art based on the embodiments of the present disclosure without creative efforts shall fall within the protection scope of the present disclosure.

With regard to user information related data such as users'trigger operations, team attributes or character features in embodiments of the present disclosure, when the embodiments of the present disclosure are applied to a specific product or technology, user permission or consent is required, and collection, use, and processing of related data need to comply with related laws, regulations, and standards in related countries and regions.

“Some embodiments” involved in the following description describes a subset of all possible embodiments. However, “some embodiments” may be same or different subsets of all the possible embodiments, and may be combined with each other when there is no conflict.

In the following description, the terms “first”, “second”, and “third” are merely intended to distinguish between similar objects and do not indicate a specific sequence of the objects. A specific order or sequence of the “first”, “second”, and “third” may be interchanged if permitted, so that the embodiments of the present disclosure described herein may be implemented in a sequence other than the sequence illustrated or described herein.

In the embodiments of the present disclosure, a term “module” or “unit” refers to a computer program having a predetermined function or a part of a computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

Unless otherwise defined, meanings of all technical and scientific terms used herein are the same as those usually understood by those skilled in the art to which the present disclosure belongs. The terms used in this specification are merely intended to describe the objectives of the embodiments of the present disclosure, but are not intended to limit the present disclosure.

Embodiments of the present disclosure provide an interaction method and apparatus for a virtual scene, an electronic device, a computer-readable storage medium, and a computer program product, so as to reduce learning cost of a card combination strategy, and improve interaction efficiency.

Before the embodiments of the present disclosure are further described in detail, terms involved in the embodiments of the present disclosure are described, and the following explanations are applicable to the terms involved in the embodiments of the present disclosure.
1) A client is an application that is run on a terminal to provide various services, for example, a video play client or a game client.
2) “In response to” is configured for representing a condition or a status on which an executed operation depends, and when a dependent condition or status is met, one or more executed operations may be in real time or may have a set delay; unless otherwise specified, there is no restriction on the order in which multiple operations are executed.
3) A virtual scene is a virtual scene displayed (or provided) by an application running on a terminal. The virtual scene may be a simulated environment of a real world, or may be a semi-simulated and semi-fictional virtual environment, or may be a completely fictional virtual environment. The virtual scene may be any one of a two-dimensional virtual scene, a 2.5-dimensional virtual scene, or a three-dimensional virtual scene. A dimension of the virtual scene is not limited in the embodiments of the present disclosure. For example, the virtual scene may include the sky, the land, the ocean, and the like. The land may include an environment element like a desert or a city, and a user may control a virtual object to move in the virtual scene.
4) Virtual character: in card games, virtual characters are the images of various people and things carried by virtual cards that can interact in virtual scenes, or movable objects in the virtual scenes. These movable objects may be virtual characters, virtual animals, cartoon characters, etc., such as characters and animals displayed in the virtual scenes. The virtual character may be a virtual image configured to represent a user in the virtual scene. The virtual scene may contain multiple virtual characters, and each virtual character corresponds to a virtual card. Each virtual character has own shape and volume in the virtual scene, and occupies part of space in the virtual scene. The virtual character may alternatively be a game character controlled by the user (or referred to as a player).
5) Virtual skills are various special functions that may assist a virtual character in interacting with an enemy character in a virtual scene. There are multiple types of virtual skills, for example, an attack-type skill that assists the virtual character in attacking the enemy character, a defense-type skill that assists the virtual character in defending against the enemy character, or a skill that causes damage to the enemy character or enhances an own attribute or an attribute of a friend character.

Embodiments of the present disclosure provide an interaction method and apparatus for a virtual scene, an electronic device, a computer-readable storage medium, and a computer program product, so as to improve interaction efficiency. The following describes an exemplary application of an electronic device in accordance with the embodiments of the present disclosure. The electronic device in accordance with the embodiments of the present disclosure may be implemented as various types of user terminals such as a laptop computer, a tablet computer, a desktop computer, a set-top box, a mobile device (for example, a mobile phone, a portable music player, a personal digital assistant, a dedicated messaging device, and a portable gaming device), a smartphone, a smart speaker, a smart watch, a smart television, and an on-board terminal, or may be implemented as a server. Exemplary applications are described below by using examples in which the device is implemented as a terminal.

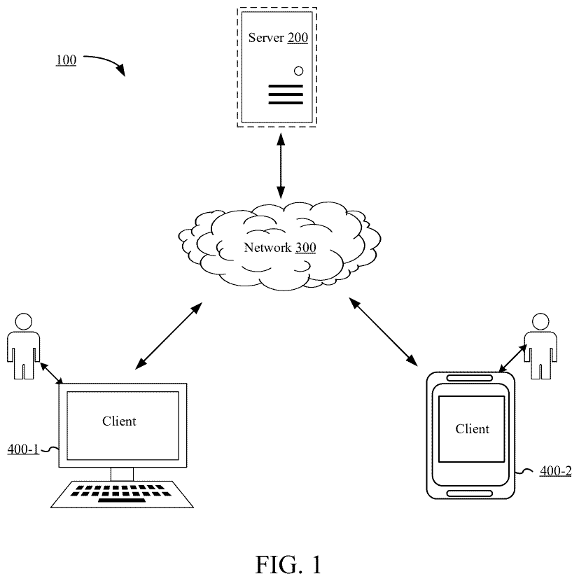

FIG. 1 is a schematic diagram of an architecture of an interaction system for a virtual scene 100 in accordance with an embodiment of the present disclosure. To support an exemplary application, terminals (a terminal 400-1 and a terminal 400-2 are exemplarily shown) are connected to a server 200 through a network 300. The network 300 may be a wide area network, a local area network, or a combination thereof.

In some embodiments, a client is disposed on the terminal. The server 200 is a backstage server corresponding to the client, or may be an independent physical server, or may be a server cluster formed by a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal and the server may be connected directly or indirectly via wired or wireless communication means.

During actual application, a terminal displays at least one virtual card in a card area of a virtual scene, each virtual card carrying a virtual character and at least one virtual skill associated with the virtual character. A character control request is transmitted to the server 200 in response to a character control instruction triggered based on the target virtual card. The server 200 acquires, in response to the character control request, a target virtual character carried in the target virtual card, and returns the target virtual character to the terminal. The terminal controls the target virtual character to move to a target position in an interaction area of the virtual scene. A skill control request is transmitted to the server 200 in response to a skill release instruction triggered based on the target virtual card. The server 200 acquires, in response to the skill control request, a target virtual skill associated with the target virtual character, and returns the target virtual skill to the terminal. The terminal controls the target virtual character to release the associated target virtual skill.

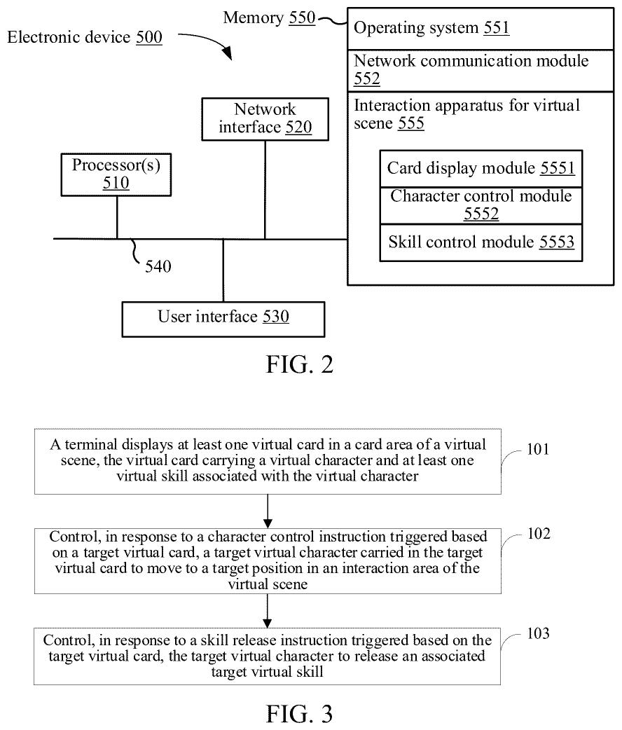

FIG. 2 is a schematic structural diagram of an electronic device 500 in accordance with an embodiment of the present disclosure. With the electronic device 500 being the terminal in FIG. 1 as an example, the electronic device 500 shown in FIG. 2 includes: at least one processor 510, a memory 550, at least one network interface 520, and a user interface 530. Components in the electronic device 500 are coupled together by using a bus system 540. The bus system 540 is configured to implement connection and communication between these components. In addition to a data bus, the bus system 540 further includes a power bus, a control bus, and a state signal bus. However, for ease of clear description, all types of buses are marked as the bus system 540 in FIG. 2.

The processor 510 may be an integrated circuit chip, and has a signal processing capability, for example, a general-purpose processor, a digital signal processor (DSP), another programmable logic device, a discrete gate or transistor logic device, or a discrete hardware component. The general-purpose processor may be a microprocessor or any conventional processor.

The memory 550 includes a volatile memory or a non-volatile memory, or may include both a volatile memory and a non-volatile memory. The non-volatile memory may be a read-only memory (ROM), and the volatile memory may be a random access memory (RAM). The memory 550 described in the embodiments of the present disclosure is to include any other suitable type of memories. In some embodiments, the memory 550 includes one or more storage devices physically away from the processor 510.

In some embodiments, the memory 550 can store data to support various operations. Examples of the data include a program, a module, and a data structure, or a subset or a superset thereof, which are exemplarily described below.

An operating system 551 includes a system program configured to process various basic system services and perform hardware-related tasks, for example, a frame layer, a core library layer, and a driver layer, and the operating system is configured to implement various basic services and process hardware-based tasks. A network communication module 552 is configured to reach another electronic device via one or more (wired or wireless) network interfaces 520. Exemplary network interfaces 520 include: Bluetooth, wireless compatibility authentication (WiFi), a universal serial bus (USB), and the like.

In some embodiments, the interaction apparatus for the virtual scene in accordance with the embodiments of the present disclosure may be implemented by using software. The interaction apparatus for the virtual scene in accordance with the embodiments of the present disclosure may be provided as various software embodiments, including various forms such as an application, software, a software module, a script, or code. FIG. 2 shows an interaction apparatus for a virtual scene 555 stored in the memory 550. The apparatus may be software in a form of a program, a plug-in, or the like, and includes a series of modules, including a card display module 5551, a character control module 5552, and a skill control module 5553. These modules are logical modules, and therefore may be combined in different manners or further split based on implemented functions. Functions of the modules are described below.

In some other embodiments, the apparatus in accordance with the embodiments of the present disclosure may be implemented in a hardware manner. As an example, the apparatus in accordance with the embodiments of the present disclosure may be a processor in the form of a hardware decoding processor. The processor is programmed to perform the interaction method for the virtual scene in accordance with the embodiments of the present disclosure. For example, the processor in the form of a hardware decoding processor may adopt one or more application specific integrated circuits (ASICs), digital signal processors (DSPs), programmable logic devices (PLDs), complex programmable logic devices (CPLDs), field-programmable gate arrays (FPGAs), or other electronic elements.

In some embodiments, the terminal or the server may implement the interaction method for the virtual scene in accordance with the embodiments of the present disclosure by running various computer-executable instructions or a computer program. For example, the computer-executable instruction may be a microprogram-level command, a machine instruction, or a software instruction. The computer program may be a native program or a software module in an operating system; may be a native application (APP), for example, a program that needs to be installed in the operating system to run, such as a game APP; or may be a mini program that may be embedded in any APP, for example, a program that only needs to be downloaded into a browser environment to run. To sum up, the computer-executable instructions may be instructions in any form, and the foregoing computer program may be an application, a module, or a plug-in in any form.

As set forth, the interaction method for the virtual scene in accordance with the embodiments of the present disclosure may be implemented by various electronic devices, for example, may be implemented by either of the terminal and the server 200 in FIG. 1 alone, or may be implemented by the terminal and the server 200 in FIG. 1 collaboratively. Next, an example of performing the interaction method for the virtual scene in accordance with the embodiments of the present disclosure by the terminal in FIG. 1 alone is to be described. FIG. 3 is a flowchart of an interaction method for a virtual scene in accordance with an embodiment of the present disclosure, and operations shown in FIG. 3 are combined for description.

Operation 101: A terminal displays at least one virtual card in a card area of a virtual scene, the virtual card carrying a virtual character and at least one virtual skill associated with the virtual character.

In an actual application, a client supporting a virtual scene is installed on the terminal (for example, when the virtual scene is a card game, the corresponding client may be a card game APP). When a user opens the client installed on the terminal and the terminal runs the client, an interface of the virtual scene may be displayed on the client. The interface of the virtual scene includes an interaction area and a card area. The card area is configured to display at least one virtual card that is not selected for on-field interaction, and the interaction area is configured for interaction by a virtual character carried in the virtual card that is selected for on-field interaction.

At the beginning of each turn, a player may properly select, according to a camp and a policy of the player, a set of card groups (or sets) including a plurality of virtual cards. Alternatively, when a virtual scene is initialized, the virtual scene generates, for each player, a set of card groups including a plurality of virtual cards. The virtual card in the set of card groups is displayed in a card area. One virtual card corresponds to one virtual character and at least one virtual skill associated with the virtual character. That is, the virtual character and the virtual skill associated with the virtual character are integrated into one virtual card. A card type to which one virtual card belongs includes a character card and a skill card.

The at least one virtual card displayed in the card area is not selected by the player for on-field interaction. The player may select a virtual card for on-field interaction from the card area, and the virtual card selected by the player moves to the interaction area for interaction.

Operation 102: Control, in response to a character control instruction triggered based on a target virtual card, a target virtual character carried in the target virtual card to move to a target position in an interaction area of the virtual scene.

In some embodiments, the terminal may control, in response to the character control instruction triggered based on the target virtual card in the following manner, the target virtual character carried in the target virtual card to move to the target position in the interaction area of the virtual scene: controlling, in response to a selection operation on the target virtual card, the target virtual character carried in the target virtual card to be in an operable state; controlling, in response to a character control instruction triggered for a dragging operation on the target virtual character, the target virtual character to move to the target position indicated by the character control instruction, the target position being a release position of the dragging operation in the interaction area of the virtual scene.

The target virtual card is any virtual card of the at least one virtual card displayed in the card area. Because the virtual character and the virtual skill associated with the virtual character are integrated onto a virtual card, and the virtual skill exists depending on existence of the virtual character, when the virtual card is selected for the first time, a card type to which the virtual card currently belongs is a character card by default. In other words, when the user selects to use the target virtual card, a default card type of the target virtual card is a character card, that is, the terminal responds to the trigger operation on the target virtual card. The target virtual character carried in the target virtual card is controlled to be in the operable state (the target virtual character in the operable state may be dragged to the interaction area). When the user drags the target virtual character to the target position in the interaction area and releases/casts the dragging operation on the target virtual character at the target position, the target position is a position for release the dragging operation (that is, a release position of the dragging operation). The terminal receives a corresponding character control instruction, and controls, in response to the character control instruction, the target virtual character to move to the target position. In the foregoing manner, the user may drag the target virtual character to any position in the interaction area through the dragging operation, that is, the user may control, through the dragging operation, the target virtual character to move to any position in the interaction area.

In some embodiments, before the terminal controls the target virtual character to move to the target position indicated by the character control instruction, the terminal may further display placement position indication information in the interaction area of the virtual scene. The placement position indication information is configured for indicating a placeable position for the target virtual character, to instruct to trigger release of the dragging operation at the placeable position.

The terminal displays the placement position indication information in the interaction area of the virtual scene in a process in which the user drags the target virtual character to move, to indicate a placeable area or a placeable position in which the target virtual character may be placed. In this way, the user determines a dragging direction and a dragging distance for the target virtual character according to the placement position indication information, and casts the dragging operation on the target virtual character at an appropriate position (that is, the placeable position), to place the target virtual character at the appropriate position (that is, the placeable position), and control the target virtual character at the appropriate position to interact in the interaction area, for example, attacking another virtual character.

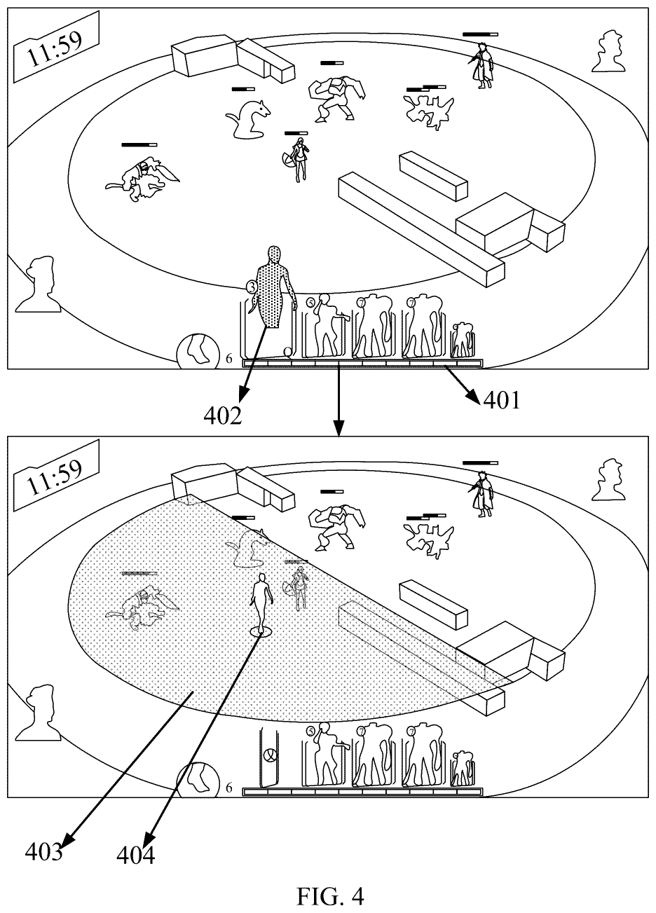

FIG. 4 is a schematic diagram of control of a virtual character in accordance with an embodiment of the present disclosure. The terminal displays a plurality of virtual cards in a card area 401. When a user selects a target virtual card, and drags a target virtual character 402 carried in the target virtual card to move to an interaction area in a virtual scene, the terminal displays placement position indication information (for example, some areas displayed in the interaction area with gray ground prints) 403 in the interaction area of the virtual scene, to indicate a placeable area (for example, some areas displayed in the interaction area with gray ground prints) or a placeable position (for example, a target position 404) in which the target virtual character 402 can be cast. When the target virtual character is dragged to the target position 404, and the user casts the dragging operation on the target virtual character at the target position 404 (for example, the user loosens the hand to release the target virtual character), the target virtual character 402 may be placed at the target position 404, to control the target virtual character 402 located at the target position 404 to perform an interaction operation, for example, attacking another virtual character.

In some embodiments, after displaying the at least one virtual card in the card area of the virtual scene, the terminal displays, in response to a selection operation on the target virtual card, a character control and a skill control. The character control is configured for triggering the character control instruction, and the skill control is configured for triggering the skill control instruction.

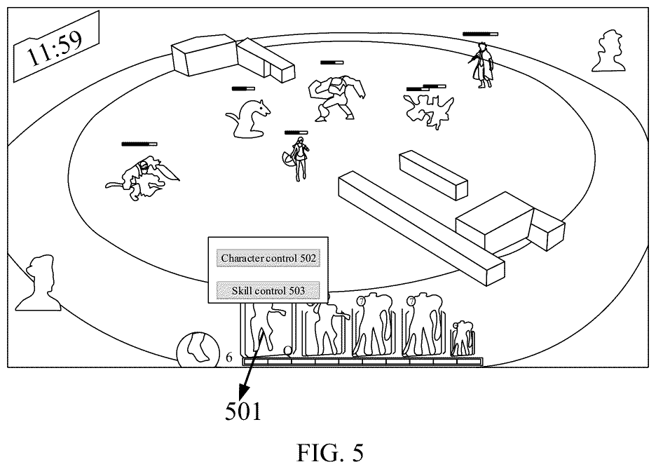

FIG. 5 is a schematic diagram of instruction triggering in accordance with an embodiment of the present disclosure. Because a card type to which a virtual card belongs includes a character card and a skill card (that is, the character card and the skill card are fused onto one virtual card), in response to the selection operation, when a user selects a target virtual card 501 (for example, the user triggers a target virtual card in a card area), the terminal may display a character control 502 and a skill control 503 for the user to select, trigger the character control instruction by using the character control 502, and trigger the skill control instruction by using the skill control 503. For example, when the user triggers the character control 502, the terminal receives, in response to the trigger operation, the character control instruction for the target virtual character carried on a target virtual card; when the target virtual character carried in the target virtual card is located in the interaction area of the virtual scene, when the user triggers the skill control 503, the terminal receives, in response to the trigger operation, the skill control instruction for the target virtual skill associated with the target virtual character. In this way, the virtual character and the virtual skill can be controlled by using one virtual card without changing a card type to which the virtual card belongs.

Operation 103: Control, in response to a skill release instruction triggered based on the target virtual card, the target virtual character to release an associated target virtual skill.

The target virtual card carries both the target virtual character and the target virtual skill associated with the target virtual character. Therefore, after the target virtual character is controlled to move to the interaction area for interaction, the target virtual character may be controlled, by using the target virtual card, to release the associated target virtual skill. Different virtual characters may be associated with different virtual skills, and the same virtual character may be associated with a plurality of virtual skills. For example, when the target virtual skill associated with the target virtual character is an attack skill, the target virtual character may be controlled to attack an enemy character by release the target virtual skill, so as to hurt the enemy character when fighting with the enemy character. For another example, when the target virtual skill associated with the target virtual character is an auxiliary skill, the target virtual character may be controlled to enhance an own attribute or an attribute of a friend character (such as life value restoration, magic value restoration, or fighting power improvement) by release the target virtual skill.

In some embodiments, before the terminal controls the target virtual character carried in a target virtual card to move to the target position in the interaction area of the virtual scene, when a card type to which the target virtual card currently belongs is a character card, the terminal receives, in response to a trigger operation on the target virtual card, a character control instruction. Correspondingly, after controlling the target virtual character carried in the target virtual card to move to the target position in the interaction area of the virtual scene, the terminal may control a card type to which the target virtual card currently belongs to be changed from a character card to a skill card, the skill card being configured to trigger the skill release instruction.

Because the target virtual card carries both the target virtual character and the virtual skill corresponding to the target virtual character, before the target virtual character is dragged out of the target virtual card, a card type to which the target virtual card belongs by default is a character card. In this case, when the user triggers the target virtual card, the character control instruction may be triggered, and the terminal may control, in response to the character control instruction, the target virtual character to move to the target position in the interaction area. After the target virtual character is dragged out of the target virtual card and the target virtual character is placed at the target position in the interaction area, a card type to which the target virtual card belongs may be controlled to be changed from a character card to a skill card, and the skill release instruction is triggered by using the target virtual card (that is, the skill card).

In some embodiments, the terminal may display the at least one virtual card in the card area of the virtual scene in the following manner: displaying a target virtual card in the at least one virtual card in a first style in a card display area of the virtual scene, the first style being configured to indicate that a card type to which the target virtual card currently belongs is a character card. Correspondingly, the terminal may control the card type currently to which the target virtual card belongs to be changed from a character card to a skill card in the following manner: updating a display style of the target virtual card from the first style to a second style, the second style being configured to instruct the card type currently to which the target virtual card belongs to be changed from a character card to a skill card.

In an actual application, a display style of the virtual card is related to a card type to which the virtual card currently belongs, that is, the display style of the virtual card reflects a card type to which the virtual card currently belongs. For example, when the card type to which the target virtual card currently belongs is a character card, the target virtual card is displayed in a first style, and when the card type to which the target virtual card currently belongs is a skill card, the target virtual card is displayed in a second style. The first style and the second style belong to different display styles. for example, different display identifiers (that is, different identifiers are displayed on the target virtual card, where the identifiers are configured to indicate a card type to which the target virtual card currently belongs. For example, the first style is to display a character identifier on the target virtual card (indicating that the card type to which the target virtual card currently belongs is a character card); and the second style is to display a skill identifier (indicating that the card type to which the target virtual card currently belongs is a skill card)), different display colors (for example, a card type of a target virtual card displayed in red is a character card, and a card type of a target virtual card displayed in green is a skill card), different display brightness (for example, a card type of a highlighted target virtual card is a character card, and a card type of a grayscale target virtual card is a skill card), different display forms (for example, a card type of a target virtual card displayed in a character form is a character card, and a card type of a target virtual card displayed in a skill form is a skill card), and the like on the target virtual card.

In some embodiments, the terminal may control a card type to which the target virtual card currently belongs to be changed from a character card to a skill card in the following manner: controlling the target virtual card to perform a form change, or controlling the target virtual card to perform card-face flip. The performing a form change or the performing card-face flip is configured for indicating that the card type to which the target virtual card currently belongs is changed, and the change of the card type includes changing from the character card to the skill card.

In an actual application, a change of a card type to which the target virtual card belongs may be embodied by an own form change or card-face flip. For example, a target virtual card in a first form represents that the card type to which the target virtual card currently belongs is a character card, and a target virtual card in a second form different from the first form represents that the card type to which the target virtual card currently belongs is a skill card. For another example, a card type to which the virtual card belongs is changed by flipping between front and back sides. Assuming that the front side of the target virtual card represents that the card type to which the target virtual card currently belongs is a character card, the back side of the target virtual card may represent that the card type to which the target virtual card currently belongs is a skill card.

In some embodiments, the terminal may control the target virtual card to perform a form change in the following manner: in response to that the target virtual character leaves card frames of the target virtual card, controlling the card frames to be merged, where a card type to which the target virtual card before merging belongs is a character card; adjusting merging progress of the card frames with movement of the target virtual character toward the target position, so that the merging progress has a negative correlation with a distance between the target virtual character and the target position; and in response to that the target virtual character is moved to the target position and placed at the target position, reorganizing the merged card frames until the merged card frames are restored to the target virtual card, a card type to which a restored target virtual card belongs being a skill card.

An example in which a card type to which the target virtual card belongs is a character card before the form change is used. When the user drags the target virtual character out of the target virtual card, and thus the target virtual character leaves a card frame under the dragging operation, the terminal may control card frames of the target virtual card to start to be merged, for example, controlling the card frame to be narrowed (that is, control a distance between two parallel card frames in the target virtual card to be reduced), and adjusting merging progress of the card frames as the target virtual character moves to the target position, so that the merging progress corresponds to a distance between the target virtual character and the target position, that is, the merging progress is used to feed back a merging degree of the card boxes. The merging progress is in a negative correlation with a distance between the target virtual character and the target position. For example, a closer distance between the target virtual character and the target position indicates larger merging progress of the card frames (that is, a merging degree is larger, that is, a distance between two parallel card frames in the target virtual card is smaller). When the target virtual character is controlled to move to the target position and the target virtual character is placed at the target position (for example, the user casts the dragging operation on the target virtual character at the target position to place the target virtual character at the target position, and the distance between the target virtual character placed at the target position and the target position is 0), after combination of the card frames is completed (that is, the two parallel card frames in the target virtual card overlap), the merged card frame starts to be reorganized (e.g., recombined). For example, the two parallel card frames that overlap are gradually expanded, so that a distance between the two parallel card frames that overlap is gradually increased, until an original distance before the card frame of the target virtual card is merged is restored, that is, the target virtual card is restored (a card size of the restored target virtual card is consistent with a card size of the target virtual card before the target virtual card is merged). In this case, a card type to which the target virtual card belongs is changed from a character card to a skill card, and the skill release instruction may be triggered by using the skill card (that is, the target virtual card), to control the target virtual character to release the associated target virtual skill.

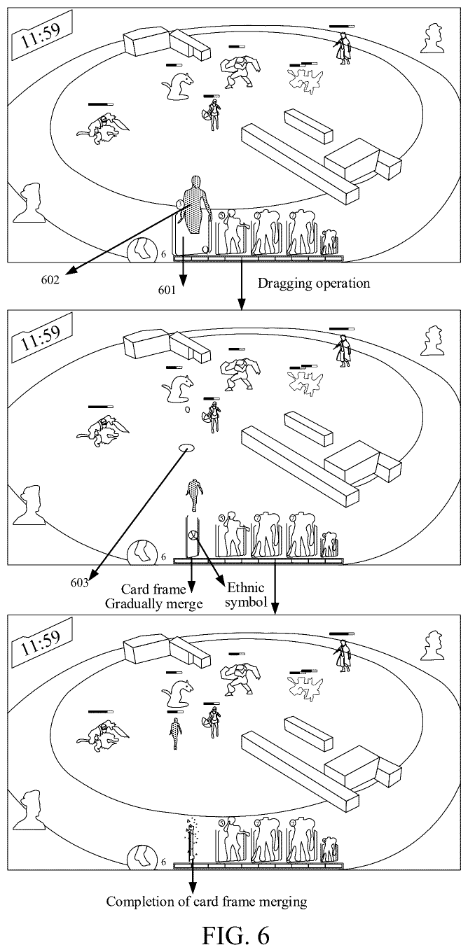

FIG. 6 is a schematic diagram of changing of a card type in accordance with an embodiment of the present disclosure. It is assumed that a card type to which a target virtual card 601 currently belongs is a character card. When a user drags a target virtual character 602 out of the target virtual card 601 to leave a card frame of the target virtual card 601, card frames of the target virtual card 601 are controlled to begin to be merged (for example, a distance between two card frames parallel in a vertical direction is controlled to be reduced). As the target virtual character 602 moves to a target position 603 in an interaction area of a virtual scene, merging progress of the card frames of the target virtual card 601 is increased (that is, the distance between the two card frames parallel in the vertical direction is gradually reduced). When the target virtual character 602 is moved to the target position 603 and is successfully placed at the target position 603, merging progress of card frames of the target virtual card 601 is completed (that is, two cards parallel in a vertical direction completely overlap). Subsequently, the merged card frame starts to be reorganized. For example, two card frames parallel in a vertical direction that overlap are gradually expanded, so that a distance between the two card frames parallel in a vertical direction that overlap is gradually increased, until an original distance before the card frames of the target virtual card are merged is restored, so as to change a card type to which the target virtual card belongs from a character card to a skill card.

In some embodiments, in the process of controlling card frames to be merged, the terminal may display a character identifier of the target virtual character in a card face area of the target virtual card, the character identifier being configured for indicating that a card type to which the target virtual card currently belongs is a character card. A skill identifier in the card face area is displayed in response to that the merged card frames are restored to the target virtual card, the skill identifier being configured for indicating that a card type to which the target virtual card currently belongs is a skill card.

In an actual application, an example in which a card type to which the target virtual card belongs before the card frames of the target virtual card are merged is a character card is used. In a process of merging the card frames of the target virtual card (that is, the card type to which the target virtual card belongs is changed), a character identifier of the target virtual character may be displayed in a card face area of the target virtual card. The character identifier includes but is not limited to: a character type identifier, a character head portrait, and an ethnic symbol of an ethnic group to which the character belongs, for example, an ethnic symbol of an ethnic group to which the character belongs shown in FIG. 6, to represent that before the card frames are merged completely, the card type to which the target virtual card currently belongs is still a character card. After card frames of the target virtual card are merged and merged card frames are reorganized to restore the target virtual card, a skill identifier shown in FIG. 6 is displayed in a card face area of the target virtual card, to indicate that a card type to which the target virtual card currently belongs is a skill card. The change from a character card to a skill card is reflected by a change of the identifier in the card face area, so that the user senses a card type to which the target virtual card belongs in real time, facilitating the user to perform an operation of a corresponding card type on the target virtual card.

In some embodiments, the terminal may display a change special-effect in a process in which card frames are merged, or in a process in which merged card frames are reorganized. The change special-effect is configured for indicating that a card type to which the target virtual card belongs is being changed.

The terminal may display a change special-effect in a process in which card frames are merged or merged card frames are reorganized (e.g., recombined), that is, in a process in which a card type to which the target virtual card belongs is changed, to indicate that the card type to which the target virtual card belongs is changing. In this way, the user may intuitively learn change progress of the card type to which the target virtual card belongs, so as to enrich display content.

In some embodiments, after the terminal controls the target virtual character to release the associated target virtual skill, the terminal may control a change of a card type to which the target virtual card belongs in the following manner: in response to that a card restoration condition is satisfied, controlling the card type to which the target virtual card currently belongs to be restored from a skill card to a character card, the character card being configured for triggering the character control instruction. The card restoration condition includes at least one of the following: the target virtual character being dead, a quantity of times of release the target virtual skill reaching a target number, and duration after the card type to which the target virtual card belongs is changed from the character card to the skill card reaching target duration.

After the card type to which the target virtual card belongs is changed from the character card to the skill card, when the card restoration condition is satisfied, the card type to which the target virtual card belongs may be controlled to be restored from the skill card to the character card. Based on this, the card type to which the target virtual card belongs may further be controlled to be changed from the character card to the skill card, that is, the card type to which the target virtual card belongs may be controlled to be cyclically changed between the character card and the skill card, to adapt to current interaction requirements.

In an actual application, because the target virtual skill associated with the target virtual character is released (or cast) depending on the target virtual character, that is, the target virtual skill exists depending on existence of the target virtual character, when the target virtual character dies in an interaction process, the target virtual skill associated with the target virtual character naturally fails. In this case, the card type to which the target virtual card belongs may be controlled to be restored from a skill card to a character card. That is, the target virtual character is dead as a card restoration condition on restoring the card type to which the target virtual card belongs from the skill card to the character card.

When the card restoration condition is related to the quantity of times of release the target virtual skill, the terminal acquires the quantity of times of controlling the target virtual character to release the target virtual skill, and when the quantity of times of controlling the target virtual character to release the target virtual skill reaches the target number (which may be set according to an actual requirement, for example, set to 3), it may be considered that the card restoration condition is satisfied. In addition, because one virtual character may be associated with a plurality of virtual skills, if the target virtual character is associated with a plurality of target virtual skills, after the target virtual character is placed in the interaction area (that is, the card type of the target virtual card is changed from a character card into a skill card): a total quantity of times of controlling the target virtual character to release the target virtual skill (which may be a same target virtual skill or different target virtual skills) may be counted. When the total quantity of times reaches the target number, it may be considered that the card restoration condition is satisfied.

In addition, because a card type to which a same virtual card belongs may be cyclically changed between a character card and a skill card, the cyclic change may be periodic change. A change period may be a fixed period, or may be a non-fixed period determined according to the interaction progress. That is, when the card restoration condition includes that duration after the card type to which the target virtual card belongs is changed from a character card to a skill card reaches the target duration, and the target duration may be fixed duration (for example, set to 5 seconds, that is, the card type is changed every 5 seconds), or non-fixed duration (for example, after the card type to which the target virtual card belongs is restored from the character card to the skill card, when the duration of the skill card reaches first target duration (the first target duration is set according to the interaction progress, for example, set to three seconds), the skill card is changed into the character card; and when the duration of the character card reaches second target duration (the second target duration is also set according to the interaction progress, and may be different from the first target duration, for example, set to 5 seconds), the character card is changed into the skill card). This cyclically switches, to implement change between different card types to which a same virtual card belongs.

After the card type to which the target virtual card belongs is restored from the skill card to the character card, the foregoing process (for example, operation 102 to operation 103) may be repeated. That is, the target virtual character is placed in the interaction area in the virtual scene again by using the character card. After the target virtual character is placed in the interaction area, the card type to which the target virtual card belongs is controlled to be changed from the character card to the skill card, and the target virtual character is controlled, by using the skill card, to release the associated target virtual skill. In this way, the virtual character and the virtual skill can be double-controlled by controlling one virtual card, so as to reduce learning cost of a card combination strategy, and improve interaction efficiency.

In some embodiments, the terminal may control, in response to the skill release instruction triggered based on the target virtual card in the following manner, the target virtual character to release an associated target virtual skill: displaying a skill indicator at an associated position of the target virtual character in response to a trigger operation on the target virtual card, the skill indicator being configured for indicating an acting range of the target virtual skill when the target virtual character casts the associated target virtual skill at the associated position; receiving, in response to that a target virtual card is dragged to an associated position, and a dragging operation on the target virtual card is released at the associated position, a skill release instruction; and controlling, in response to the skill release instruction, the target virtual character to release the target virtual skill at the associated position.

In an actual application, influences that can be brought by release the target virtual skill at different positions in the interaction area may be different. For example, when the target virtual skill is released at a position having an obstacle in the interaction area, the target virtual skill may not play all roles. For another example, when the target virtual skill is released in an area in which there is no enemy virtual character in the interaction area, the enemy virtual character cannot be negatively influenced. Therefore, when the target virtual character is in the interaction area, the user is prompted, by using the acting range indicated by the skill indicator, to release the target virtual skill in the acting range to bring a maximum benefit to the target virtual character. The user may be guided to release the target virtual skill in the acting range indicated by the skill indicator, so that a skill of the target virtual skill can be exerted as much as possible or a maximum negative influence is brought on a local virtual character as much as possible.

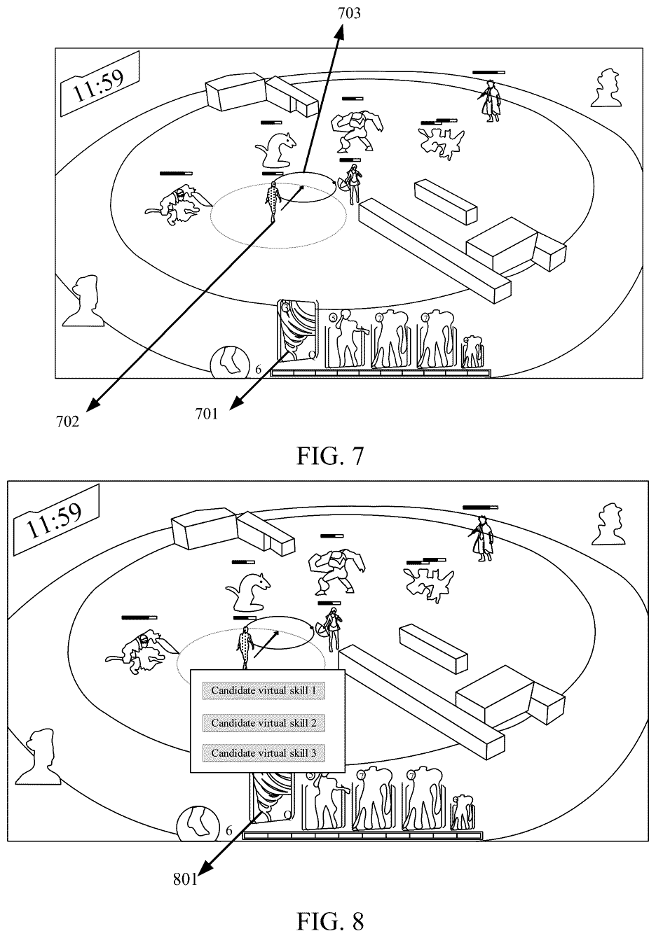

FIG. 7 is a schematic diagram of skill release in accordance with an embodiment of the present disclosure. When a card type to which a target virtual card currently belongs is a skill card, the terminal displays, in response to a trigger operation on a target virtual card 701, a skill indicator 703 at an associated position (for example, a peripheral position of the target virtual character, for example, at an upper right 5 meters) of a target virtual character 702 located in an interaction area of a virtual scene, to indicate an acting range of skill release (for example, a skill release direction, and a target object that can be acted on after the skill is cast). Based on guidance of the skill indicator, the user may determine whether to trigger the skill release instruction or at which position to trigger the skill release instruction. When the user determines to trigger the skill release instruction, the target virtual card (that is, the skill card) may be dragged to a position (that is, the foregoing associated position) at which the skill indicator is located and then cast. The terminal receives the skill release instruction in response to the series of operations (for example, a dragging operation on the target virtual card and a release operation on the target virtual card), and controls, in response to the skill release instruction, the target virtual character to release the target virtual skill at the associated position.

In an actual application, the skill release instruction may be triggered without using the foregoing series of operations. For example, when the skill indicator is displayed at the associated position of the target virtual character, the user does not need to drag the target virtual card to a position of the skill indicator. When the target virtual card (that is, a skill card) is triggered (for example, one-click, double-click), the terminal may receive the skill release instruction in response to the trigger operation, and control, in response to the skill release instruction, the target virtual character to release the target virtual skill at the associated position. That is, the skill release instruction may be triggered by means of one-click triggering, so as to improve interaction efficiency.

In some embodiments, before the terminal controls the target virtual character to release the associated target virtual skill, when there are at least two virtual skills associated with the target virtual character, the terminal may display, in response to a trigger operation on the target virtual card, at least two candidate virtual skills associated with the target virtual character; and receive, in response to a selection operation on a target virtual skill, a skill release instruction configured for instructing to release the target virtual skill.

In an actual application, when a target virtual character is associated with a plurality of virtual skills, if the target virtual character carried in the target virtual card has been moved to a target position in an interaction area of a virtual scene, that is, when a card type to which the target virtual card currently belongs is a skill card: if the user triggers the target virtual card (that is, a skill card), the terminal displays, in response to the trigger operation, the plurality of virtual skills associated with the target virtual character as candidate virtual skills for the user to select. When the user selects a target virtual skill from the plurality of candidate virtual skills, the terminal can receive, in response to the selection operation, the skill release instruction configured for instructing to release the target virtual skill.

FIG. 8 is a schematic diagram of skill release in accordance with an embodiment of the present disclosure. Because a same virtual character may be associated with a plurality of virtual skills, when a target virtual character is associated with a plurality of virtual skills, when a user triggers a target virtual card (that is, a skill card) 801, the terminal displays, in response to the trigger operation, at least two candidate virtual skills, for example, a candidate virtual skill 1, a candidate virtual skill 2, and a candidate virtual skill 3, associated with the target virtual character that may be selected by the user. The terminal receives, in response to a selection operation on the target virtual skill (for example, the candidate virtual skill 2), a skill release instruction, the skill release instruction being configured for instructing to release the target virtual skill (that is, the candidate virtual skill 2), and controls, in response to the skill release instruction, the target virtual character to release the target virtual skill (that is, the candidate virtual skill 2). In this way, the user may select, according to an actual requirement, a suitable virtual skill for releasing or casting, so as to improve skill release pertinence, and further improve interaction efficiency.

When a plurality of candidate virtual skills is displayed for selection by a user, when selection priorities corresponding to the candidate virtual skills are different, each candidate virtual skill may further be displayed in a corresponding display style according to a selection priority corresponding to each candidate virtual skill. That is, for candidate virtual skills with different selection priorities, each candidate virtual skill is displayed in different display styles (for example, different display orders, different display colors, different display brightness, different display fonts), or a candidate virtual skill with a relatively high selection priority is displayed in highlight, so that the user selects a required candidate virtual skill, facilitating improving pertinence of skill release and interaction efficiency.

In some embodiments, the terminal may control, in the following manner, the target virtual character to release an associated target virtual skill: when there are at least two virtual skills associated with the target virtual character, acquiring an influence parameter configured for influencing a release priority of each virtual skill, the influence parameter including at least one of the following: an effective acting range corresponding to the releases of the virtual skill, and a matching degree between the virtual skill and interaction progress at which the target virtual character is currently located; and calling, based on the influence parameter, a neural network model to perform release priority prediction processing, to obtain a release priority of each virtual skill; and controlling the target virtual character to release a target virtual skill having the highest release priority among the virtual skills.

The same virtual character may be associated with a plurality of virtual skills, that is, when the target virtual character is associated with a plurality of virtual skills, the terminal acquires, in response to a trigger operation on a target virtual card (that is, a skill card), a release priority corresponding to each virtual skill, and controls the target virtual character to automatically cast a target virtual skill having a highest release priority in the plurality of associated virtual skills. That is, the release priority of the target virtual skill is higher than the release priority of another virtual skill other than the target virtual skill in the at least two virtual skills, to improve pertinence of skill release and interaction efficiency.

When the release priority corresponding to each virtual skill is acquired, an influence parameter influencing the release priority of each virtual skill is acquired at first, where a larger effective acting range corresponding to the release of a virtual skill indicates a larger corresponding release priority of the virtual skill. With regard to a matching degree between a virtual skill and interaction progress at which the target virtual character is currently located, the matching degree is configured for representing a corresponding degree of urgency at which the target virtual character currently casts different virtual skills. For example, virtual skills associated with the target virtual character include an attack virtual skill and a defense virtual skill. If the target virtual character is currently located in interaction progress in which the target virtual character is surrounded by an enemy and needs to enhance a defense capability, a matching degree between the attack virtual skill and the interaction progress is lower than a matching degree between the defense virtual skill and the interaction progress. If the target virtual character is currently in interaction progress in which an enemy party is attacked and an attack capability needs to be enhanced, a matching degree between the attack virtual skill and the interaction progress is higher than a matching degree between the defense virtual skill and the interaction progress. Usually, a larger matching degree indicates a larger release priority of a corresponding virtual skill. After the influence parameter is acquired, the influence parameter is input into the trained neural network model for prediction processing, to obtain the release priority corresponding to each virtual skill, so that prediction can be more accurate.

Before the neural network model is applied, an initial neural network model needs to be trained, and then the trained neural network model is put into application, to predict a release priority corresponding to a virtual skill by using an artificial intelligence technology with reference to the influence parameter. The neural network model is obtained through training by using a virtual skill sample, an influence parameter corresponding to the virtual skill sample, and a release priority marked by the virtual skill sample. For example, an initial neural network model is called to perform prediction processing based on a virtual skill sample, a matching degree associated with the virtual skill sample, and a release priority marked by the virtual skill sample, to obtain a predicted release priority. After a value of a loss function of the neural network model is determined by using the predicted release priority and the marked release priority, whether the value of the loss function exceeds a preset threshold may be determined. When the value of the loss function exceeds the preset threshold, an error signal of the neural network model is determined based on the loss function, the error signal is back-propagated in the neural network model, and a model parameter of each layer is updated in a propagation process.

A model structure of the neural network model is not limited in the embodiment of the present disclosure. For example, the neural network model may be a convolutional neural network, a deep neural network, or the like. The form of the loss function is not limited to the form of the loss function. For example, the loss function may be a cross-entropy loss function or an L2 loss function.

The back propagation is described. The training sample data is input to an input layer of the neural network model, passes through a hidden layer, and finally reaches an output layer and a result is output. This is a forward propagation process of the neural network model. Because there is an error between the output result and an actual result of the neural network model, an error between the output result and an actual value is calculated, and the error is back-propagated from the output layer to the hidden layer until the error is propagated to the input layer. In the back propagation process, the value of the model parameter is adjusted according to the error, that is, a loss function is constructed according to the error between the output result and the actual value, and a partial derivative of the loss function for the model parameter is solved layer by layer. A gradient of the loss function for each layer of the model parameter is generated. Because a direction of the gradient indicates a direction of error expansion, the gradient of the model parameter is inversed, and the original parameter of each layer of the model is added to the gradient. An obtained summation result is used as an updated layer of the model parameter, to reduce an error caused by the model parameter, and the foregoing process is continuously iterated until convergence is performed.

In some embodiments, after controlling the target virtual character to release the associated target virtual skill, the terminal may control the target virtual skill associated with the target virtual card to be in a cooling state, and control the target virtual skill to be restored to an activated state from the cooling state when the cooling is completed.

In an actual application, a virtual skill usually has an effective duration (that is, when the virtual skill is cast, the effective duration of the virtual skill is limited). For a virtual skill that can be repeatedly cast, after the virtual skill is cast once, the virtual skill usually needs a particular cooling time to be cast again. Therefore, when the target virtual skill is a virtual skill that can be repeatedly cast, after controlling the target virtual skill to release the target virtual skill once, the terminal may control the target virtual skill to be in a cooling state, for example, displaying a cooling countdown. When the cooling countdown is returned to zero, the terminal controls the target virtual skill to be in an activated state, and may continue to control the target virtual character to release the target virtual skill in the activated state. In this way, a cast frequency of a virtual skill associated with the virtual character is controlled, and ecological balance of a virtual scene can be maintained.

In some embodiments, after the terminal controls the target virtual character to release an associated target virtual skill, when there are at least two virtual skills associated with the target virtual character, the terminal controls, in response to a trigger operation on the target virtual card, the target virtual character to release another associated virtual skill, the another virtual skill being different from the target virtual skill.

A same virtual character may be associated with a plurality of virtual skills, that is, if the target virtual character is associated with a plurality of virtual skills, after the terminal controls, in response to the skill release instruction, the target virtual character to release the target virtual skill, if the card type to which the target virtual card currently belongs is still a skill card, and the user triggers the target virtual card again (the card type to which the target virtual card belongs is a skill card), the terminal automatically controls, in response to the trigger operation, the target virtual character to release another virtual skill that is associated with the target virtual character and that is different from the target virtual skill. For example, the target virtual character is associated with two virtual skills (respectively, a virtual skill 1 and a virtual skill 2). controlling, by the terminal, the target virtual character to release a virtual skill 1 when the terminal receives the skill release instruction for the first time, and controlling the target virtual character to release the skill 2 when the terminal receives the skill release instruction for the second time. In this way, multiple virtual skills may be cast by using one virtual card, which is beneficial to improving interaction efficiency.

In some embodiments, if the target virtual character is associated with a plurality of virtual skills, when receiving the skill release instruction once, the terminal may control the target virtual character to simultaneously cast the plurality of virtual skills or successively cast the virtual skills. With the example in which the target virtual character is associated with two virtual skills (which are respectively a virtual skill 1 and a virtual skill 2) as an example as well, when receiving the skill release instruction, the terminal may control the target virtual character to simultaneously cast the virtual skill 1 and the virtual skill 2, or may control the target virtual character to first cast the virtual skill 1, and then control the target virtual character to release the skill 2 when release of the virtual skill 1 is finished. In this way, multiple virtual skills may be cast by using one virtual card and one skill release instruction, which is beneficial to improving interaction efficiency.

When the terminal controls the target virtual character to simultaneously cast a plurality of associated virtual skills (for example, the virtual skill 1 and the virtual skill 2), an effect brought by the terminal may be a simple superposition of effects brought by release the virtual skills (that is, the effect brought by simultaneously release the virtual skill 1 and the virtual skill 2 is the sum of the effects brought by release the virtual skill 1 and the effect brought by release the virtual skill 2), or may be a multiplication of effects brought by release the virtual skills (that is, the effect brought by simultaneously release the virtual skill 1 and the virtual skill 2 is greater than the sum of the effects brought by release the virtual skill 1 and the effect brought by release the virtual skill 2).

In the foregoing manner, at least one virtual card is displayed in the card area of the virtual scene. One virtual card carries a virtual character and at least one virtual skill associated with the virtual character, that is, the virtual character and the virtual skill associated with the virtual character are integrated into one virtual card, so that each virtual card has higher strategic performance. Therefore, a player only needs to operate one virtual card (for example, a target virtual card), to control interaction of the target virtual character carried in the virtual card in the virtual scene, and to control the target virtual character to release a target virtual skill associated with the target virtual character, so as to reduce learning cost of a card combination strategy, and improve interaction efficiency.

Next, an exemplary application of the embodiment of the present disclosure in an actual application scene is to be described. An interaction method for a virtual scene in accordance with the embodiments of the present disclosure is described sequentially with the virtual scene being a card game as an example. FIG. 9 is a flowchart of an interaction method for a virtual scene in accordance with an embodiment of the present disclosure. The method includes:

Operation 201: A terminal displays at least one virtual card in a card area of a game.

At the beginning of each turn, a player may properly select a set of card groups according to a camp and a policy of the player. Alternatively, when the game is initialized, the game generates a set of card groups for each player. One set of card groups includes multiple (for example, four) virtual cards, and the virtual cards in the set of card groups are displayed in a card area of the game.

One virtual card corresponds to one virtual character and at least one virtual skill associated with the virtual character, that is, the virtual character and the virtual skill associated with the virtual character are integrated onto one virtual card. A card type to which one virtual card belongs includes a character card and a skill card. Because the virtual skill is cast depending on the virtual character, a card type to which each virtual card belongs is a character card by default.

Operation 202: control, in response to a selection operation on a target virtual card, a target virtual character carried in the target virtual card to be in an operable state.

The target virtual card is any virtual card in the card set. As described above, a card type to which the target virtual card belongs by default is a character card. When the user selects the target virtual card (that is, the character card), the terminal controls, in response to the trigger operation, the target virtual character associated with the target virtual card to be in the operable state. The target virtual character in the operable state may be dragged to the interaction area of the game.

Operation 203: Place, in response to a placement instruction for the target virtual character, the target virtual character at a target position in the interaction area.

The placement instruction is the foregoing character control instruction. When the user drags the target virtual character from the target virtual card, the terminal controls the target virtual character to move with the dragging operation. When the target virtual character is dragged to the target position in the interaction area of the game and the dragging operation on the target virtual character is cast at the target position, the target virtual character may be placed at the target position.

The placement position indication information in the interaction area of the game is displayed in a process in which the target virtual character is dragged to move, to indicate a placeable area or a placeable position in which the target virtual character may be placed. In this way, the user determines a dragging direction and a dragging distance for the target virtual character according to the placement position indication information, and casts the dragging operation on the target virtual character at an appropriate position (that is, the placeable position), to place the target virtual character at the appropriate position (that is, the placeable position), and control the target virtual character at the appropriate position to interact in the interaction area, for example, attacking another virtual character.

Operation 204: Control a card type to which the target virtual card currently belongs to be changed from a character card to a skill card.

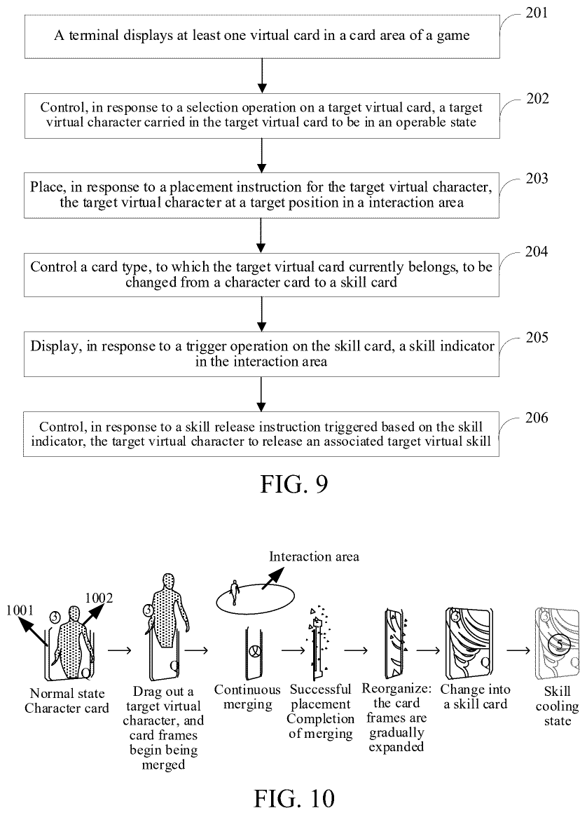

In an actual application, a change of a card type to which a target virtual card belongs may be embodied by a form change of the target virtual card according to an embodiment of the present disclosure. FIG. 10 is a schematic diagram of changing of a card type in accordance with an embodiment of the present disclosure. Assuming that in a normal state, a card type to which a target virtual card 1001 currently belongs is a character card, when a user drags a target virtual character 1002 out of the target virtual card 1001 to leave a card box, the card frame is controlled to be merged (or the card frame is contracted, that is, a distance between two vertically and parallel card frames is reduced), that is, the target virtual card is controlled to be contracted, and a card face displays an ethnic symbol of an ethnic group to which the target virtual character belongs. As the target virtual character 1002 moves toward the placement position (that is, the foregoing target position) in the interaction area of the virtual scene, the card frame merging progress is increased (that is, the distance between the two vertically and parallel card frames is gradually decreased). When the target virtual character 1002 moves to the placement position and is successfully placed at the placement position, the card frame merging progress is completed (that is, the two vertically and parallel card frames are merged together). A change special-effect (for example, exposing or displaying a fragmentation element) is displayed after the target virtual character is completely placed. Subsequently, the merged card frames start to be reorganized. For example, two overlapped parallel card frames are gradually expanded, so that a distance between the two overlapped parallel card frames gradually becomes larger, until an original distance before the card frames of the target virtual card are merged is restored, so as to change a card type to which the target virtual card belongs from a character card to a skill card, and controlling the skill card to be in a cooling state.

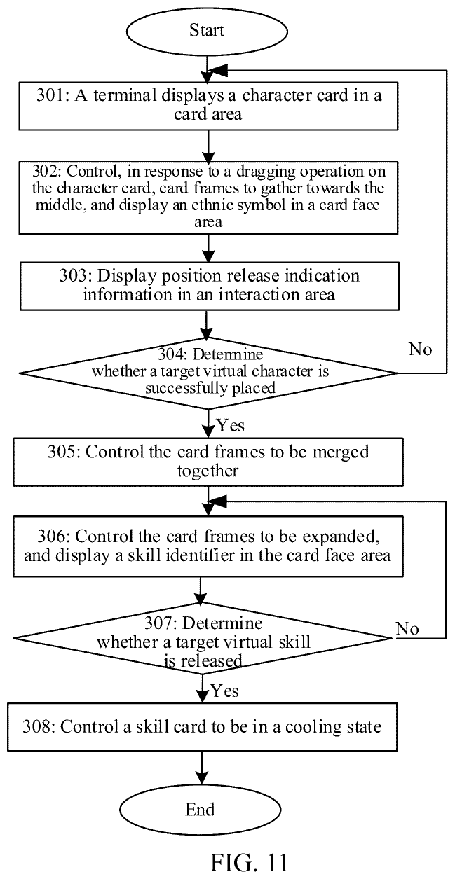

In conjunction with FIG. 10, FIG. 11 is a schematic flowchart of a changing method of a card type in accordance with an embodiment of the present disclosure. The method includes:

Operation 301: A terminal displays a character card in a card area.

The character card is the foregoing target virtual card to which a card type is a character card belongs, the character card is in an operable state, a card frame is in an open state, and a character image of the target virtual character is displayed in a card face area of the character card.

Operation 302: Control, in response to a dragging operation on the character card, card frames to gather towards the middle, and display an ethnic symbol in a card face area.

The ethnic symbol is the symbol indicating the race of the target virtual character carried by the character card. That is, it is the aforementioned character identifier. The ethnic symbol indicates that the card type to which the target virtual card currently belongs is a character card.

Operation 303: Display position release indication information in an interaction area.

Operation 304: Determine whether the target virtual character is successfully placed.

When the target virtual character is not successfully placed, operation 301 is performed. When the target virtual character is successfully placed, operation 305 is performed.

Operation 305: Control the card frames to be merged together.

Operation 306: Control the card frames to be expanded, and display the skill identifier in the card face area.

The skill identifier is used to indicate a virtual skill associated with the target virtual skill, and indicate that a card type to which the target virtual card currently belongs is a skill card. After the card frames are merged together, the merged card frames start to be reorganized subsequently. For example, two overlapped parallel card frames are gradually expanded, so that a distance between the two overlapped parallel card frames gradually becomes larger, until an original distance before the card frames of the target virtual card are merged is restored, so as to change a card type to which the target virtual card belongs from a character card to a skill card.

Operation 307: Determine whether the target virtual skill is cast.

When the target virtual skill is not cast, operation 306 is performed. When the target virtual skill is cast, operation 308 is performed.

Operation 308: Control the skill card to be in a cooling state.

When the target virtual skill is cast, that is, after the target virtual character is controlled to release the target virtual skill, the skill card is controlled to enter a cooling state.

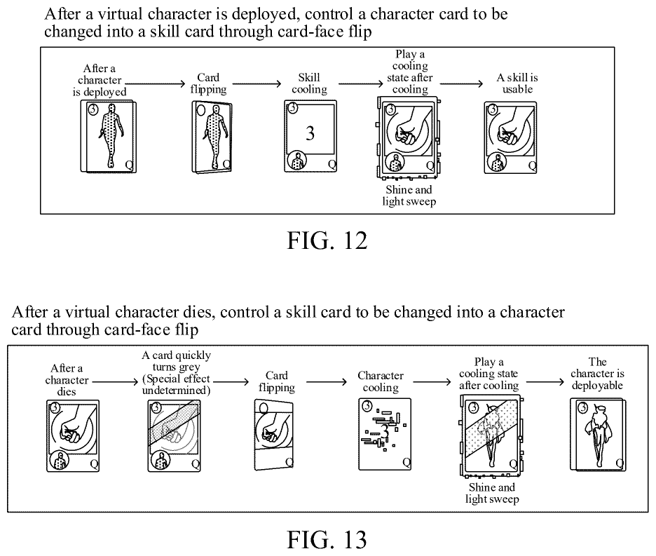

In an actual application, a change of a card type to which a target virtual card belongs may be embodied through card-face flip. FIG. 12 is a schematic diagram of changing of a card type in accordance with an embodiment of the present disclosure. Before a target virtual character associated with a target virtual card is moved to an interaction area (that is, the character is deployed), a terminal displays the front side of the target virtual card, and displays a character identifier (for example, a character avatar) of the target virtual character in a card face area of the target virtual card. That is, the front side represents that a card type to which the target virtual card belongs is a character card. After the target virtual character associated with the character card is placed at the target position in the interaction area (that is, the character is deployed), the character card is controlled to perform card-face flip (i.e., from displaying the front side of the card to displaying the back side of the card), that is, the back side of the target virtual card is displayed, to change a card type to which the target virtual card belongs from the character card into a skill card, that is, the back side represents that a card type to which the target virtual card belongs is a skill card. In addition, in a process of cooling the skill token, a character identifier (for example, a character avatar, indicating that the character identifier is associated with the target virtual character) of the target virtual character may be displayed at a bottom position (for example, lower left) of a card face area of the skill card. After the skill card is completely cool, a skill identifier (for example, a skill icon in a form of a fist) of the target virtual skill may be displayed in a card face area of the skill card, and the player may control, by clicking the skill card, the target virtual character to release the associated target virtual skill.

FIG. 13 is a schematic diagram of changing of a card type in accordance with an embodiment of the present disclosure. After a target virtual character is dead, because a virtual skill is cast depending on the target virtual character, a skill card may be controlled to perform card-face flip to change to a character card. In this case, the character card is in a cooling state. Therefore, a cooling countdown corresponding to the character card may be displayed, and a cooling special-effect is played in a process of returning the cooling countdown to zero. After cooling is finished (that is, the cooling countdown is returned to zero), the character card is controlled to be in an activated state, and a player may trigger the character card in the activated state to place the target virtual character in an interaction scene for interaction again.

Operation 205: Display, in response to a trigger operation on the skill card, a skill indicator in the interaction area.

The skill indicator is configured to indicate an acting range of the target virtual skill when the target virtual character casts the associated target virtual skill at the associated position. The user may select a skill release position based on the skill indicator.

Operation 206: Control, in response to a skill release instruction triggered based on a skill indicator, the target virtual character to release an associated target virtual skill.

After determining the skill release position (that is, the foregoing associated position) based on the skill indicator, the user may drag the skill card (that is, the target virtual card) to the determined release position, and cast dragging for the skill card at the release position, to trigger the skill release instruction. The terminal controls, in response to the skill release instruction, the target virtual character to release the associated target virtual skill at the release position, for example, controls the target virtual character to cause damage to an enemy character or enhance an attribute (such as a life value and fighting power) of the target virtual character or a friend character by release the target virtual skill.

Through the above methods, the embodiments of the present disclosure at least include the following beneficial effects:
1) Simplifying an operation: because the virtual character and the virtual skill are integrated into one virtual card, the player can deploy the virtual character and cast the virtual skill by operating only one virtual card. This greatly simplifies an operation process of a game, makes it easier for the game to put on hands, and also improves smoothness of the game.
2) Increasing strategic performance: each virtual card includes a virtual character and a virtual skill, so that each virtual card has higher strategy, and a player needs to consider how to use the virtual character and the virtual skill of the virtual card, which increases strategical performance and depth of a game.
3) Reducing a memory load: one virtual card may carry two types of function information, and by means of dynamic changing of the virtual card, a player can clearer and more clearly understand an association between a virtual skill and a virtual character without viewing details or deliberately memorizing the virtual skill and the virtual character.

The interaction method for a virtual scene in accordance with the embodiments of the present disclosure is described with reference to the exemplary application and implementation of the electronic device in accordance with the embodiments of the present disclosure. The following further describes how the modules in the interaction apparatus for a virtual scene 555 in accordance with the embodiments of the present disclosure cooperate with each other to implement the interaction method for the virtual scene.

A card display module 5551 is configured to display at least one virtual card in a card area of a virtual scene, the virtual card carrying a virtual character and at least one virtual skill associated with the virtual character; a character control module 5552 is configured to control, in response to a character control instruction triggered based on a target virtual card, a target virtual character carried in the target virtual card to move to a target position in an interaction area of the virtual scene; and a skill control module 5553 is configured to control, in response to a skill release instruction triggered based on the target virtual card, the target virtual character to release an associated target virtual skill.

In some embodiments, before controlling the target virtual character carried in a target virtual card to move to the target position in the interaction area of the virtual scene, the apparatus further includes: an instruction receiving module, configured to receive, in response to a trigger operation on the target virtual card, a character control instruction when a card type to which the target virtual card currently belongs is a character card. Correspondingly, after controlling the target virtual character carried in the target virtual card to move to the target position in the interaction area of the virtual scene, the apparatus further includes: a card changing module, configured to control a card type to which the target virtual card currently belongs to be changed from a character card to a skill card, the skill card being configured to trigger the skill release instruction. In some embodiments, the card display module is further configured to display a target virtual card in the at least one virtual card in a first style in a card display area of the virtual scene, the first style being configured to indicate that a card type to which the target virtual card currently belongs is a character card; and the card changing module is further configured to update a display style of the target virtual card from the first style to a second style, the second style being configured for indicating that the card type to which the target virtual card currently belongs is changed from the character card to a skill card.

In some embodiments, the card changing module is further configured to: control the target virtual card to perform a form change, or control the target virtual card to perform card-face flip, the performing a form change or the performing card-face flip being configured for indicating that the card type to which the target virtual card currently belongs is changed, and the change of the card type includes changing from the character card to the skill card.

In some embodiments, the card changing module is further configured to: in response to that the target virtual character leaves card frames of the target virtual card, controlling the card frames to be merged, where a card type to which the target virtual card before merging belongs is a character card; adjusting merging progress of the card frames with movement of the target virtual character toward the target position, so that the merging progress has a negative correlation with a distance between the target virtual character and the target position; and in response to that the target virtual character is moved to the target position and placed at the target position, reorganizing the merged card frames until the merged card frames are restored to the target virtual card, a card type to which a restored target virtual card belongs being a skill card.

In some embodiments, the apparatus further includes: an identification display module, configured to, in a process of controlling the card frames to be merged, display a character identifier of the target virtual character in a card face area of the target virtual card, the character identifier being configured to indicate that the card type to which the target virtual card currently belongs is a character card; and display, in response to that the merged card frames are restored to the target virtual card, a skill identifier in the card face area, the skill identifier being configured for indicating that the card type to which the target virtual card currently belongs is a skill card.

In some embodiments, the apparatus further includes: a special-effect displaying module, configured to display a change special-effect in a process of merging the card boxes, or in a process of reorganizing the merged card boxes, the change special-effect being configured for indicating that a card type to which the target virtual card belongs is changing.

In some embodiments, after controlling the target virtual character to release the associated target virtual skill, the card changing module is further configured to, in response to that a card restoration condition is satisfied, control the card type to which the target virtual card currently belongs to be restored from a skill card to a character card, the character card being configured for triggering the character control instruction. The card restoration condition includes at least one of the following: the target virtual character being dead, a quantity of times of release the target virtual skill reaching a target number, and duration after the card type to which the target virtual card belongs is changed from the character card to the skill card reaching target duration.

In some embodiments, the character control module is further configured to control, in response to a selection operation on the target virtual card, the target virtual character carried in the target virtual card to be in an operable state; control, in response to a character control instruction triggered for a dragging operation on the target virtual character, the target virtual character to move to the target position indicated by the character control instruction, the target position being a release position of the dragging operation in the interaction area of the virtual scene.

In some embodiments, before controlling the target virtual character to move to a target position indicated by the character control instruction, the apparatus further includes: an indication display module, configured to display placement position indication information in the interaction area of the virtual scene. The placement position indication information is configured for indicating a placeable position for the target virtual character, to instruct to trigger release of the dragging operation at the placeable position.

In some embodiments, the skill control module is further configured to display a skill indicator at an associated position of the target virtual character in response to a trigger operation on the target virtual card, the skill indicator being configured for indicating an acting range of the target virtual skill when the target virtual character casts the associated target virtual skill at the associated position; receive, in response to that a target virtual card is dragged to an associated position, and a dragging operation on the target virtual card is cast at the associated position, a skill release instruction; and control, in response to the skill release instruction, the target virtual character to release the target virtual skill at the associated position.

In some embodiments, after displaying the at least one virtual card in the card area of the virtual scene, the apparatus further includes: a control selection module, configured to display, in response to a selection operation on the target virtual card, a character control and a skill control. The character control is configured for triggering the character control instruction, and the skill control is configured for triggering the skill control instruction.

In some embodiments, before controlling the target virtual character to release the associated target virtual skill, the apparatus further includes: an instruction receiving module, configured to display, when there are at least two virtual skills associated with the target virtual character, in response to a trigger operation on the target virtual card, at least two candidate virtual skills associated with the target virtual character; and receive, in response to a selection operation on a target virtual skill, a skill release instruction configured for instructing to release the target virtual skill.

In some embodiments, the skill control module is further configured to: when there are at least two virtual skills associated with the target virtual character, acquire an influence parameter configured for influencing a release priority of each virtual skill, the influence parameter including at least one of the following: an effective acting range corresponding to the release of the virtual skill, and a matching degree between the virtual skill and interaction progress at which the target virtual character is currently located; call, based on the influence parameter, a neural network model to perform release priority prediction processing, to obtain a release priority of each virtual skill; and control the target virtual character to release a target virtual skill having the highest release priority.

In some embodiments, after controlling the target virtual character to release an associated target virtual skill, the apparatus further includes: a skill cooling module, configured to control the target virtual skill associated with the target virtual card to be in a cooling state, and control, when cooling is completed, the target virtual skill to be restored from the cooling state to an activated state.

In some embodiments, after controlling the target virtual character to release an associated target virtual skill, the skill control module is further configured to, when there are at least two virtual skills associated with the target virtual character, control, in response to a trigger operation on the target virtual card, the target virtual character to release another associated virtual skill, the another virtual skill being different from the target virtual skill.

Embodiments of the present disclosure provide a computer program product, the computer program product including a computer program or a computer-executable instruction, the computer program or the computer-executable instruction being stored in a computer-readable storage medium. A processor of an electronic device reads the computer-executable instruction from the computer-readable storage medium, and the processor executes the computer-executable instruction, so that the electronic device performs the interaction method for the virtual scene in the embodiments of the present disclosure.

An embodiment of the present disclosure provides a computer-readable storage medium having a computer-executable instruction therein, and having the computer-executable instruction or a computer program stored therein, the computer-executable instruction or the computer program, when executed by a processor, causing the processor to perform the interaction method for the virtual scene in accordance with the embodiments of the present disclosure, for example, the interaction method for the virtual scene shown in FIG. 3.

As such, embodiments of the present disclosure at least have the following beneficial effects. By applying the embodiments of the present disclosure, at least one virtual card is displayed in the card area of the virtual scene. One virtual card carries a virtual character and at least one virtual skill associated with the virtual character, that is, the virtual character and the virtual skill associated with the virtual character are integrated into one virtual card, so that each virtual card has higher strategic performance. Therefore, a player only needs to operate one virtual card (for example, a target virtual card), to control interaction of the target virtual character carried in the virtual card in the virtual scene, and to control the target virtual character to release a target virtual skill associated with the target virtual character, so as to reduce learning cost of a card combination strategy, and improve interaction efficiency.

In some embodiments, the computer-readable storage medium may be a memory such as a ferroelectric random access memory (FRAM), a read-only memory (ROM), a programmable read-only memory (PROM), an erasable programmable read-only memory (EPROM), an electrically erasable programmable read-only memory (EEPROM), a flash memory, a magnetic surface memory, an optical disk, or a compact disc read-only memory (CD-ROM), or may be any device including one of or any combination of the foregoing memories.

In some embodiments, the computer-executable instructions may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit applicable for use in a computing environment.

In an example, the computer-executable instruction may but do not necessarily correspond to a file in a file system, and may be stored as a part of a file that saves other programs or data, for example, stored in one or more scripts in a hyper text markup language (HTML) document, stored in a single file dedicated to a discussed program, or stored in a plurality of collaborative files (for example, files that store one or more modules, subprograms, or code parts).

For example, the computer-executable instruction may be deployed to be executed on one electronic device, or executed on a plurality of electronic devices located at one location, or executed on a plurality of electronic devices that are distributed in a plurality of locations and interconnected by a communication network.

The foregoing descriptions described above are merely examples of the embodiments of the present disclosure, and this is not intended to limit the protection scope of the present disclosure. Any modification, equivalent replacement, or improvement made within the spirit and scope of the present disclosure shall fall within the protection scope of the present disclosure.

1. An interaction method for a virtual scene, performed by an electronic device, the method comprising:
displaying at least one virtual card in a card area of the virtual scene, the virtual card carrying a virtual character and at least one virtual skill associated with the virtual character;
controlling, in response to a character control instruction triggered based on a target virtual card, a target virtual character carried in the target virtual card to move to a target position in an interaction area of the virtual scene; and
controlling, in response to a skill release instruction triggered based on the target virtual card, the target virtual character to release an associated target virtual skill.

2. The method according to claim 1, further comprising:
receiving, in response to a trigger operation on the target virtual card, the character control instruction when a card type, to which the target virtual card currently belongs, is a character card; and
controlling the card type, to which the target virtual card currently belongs, to be changed from the character card to a skill card, the skill card being configured to trigger the skill release instruction.

3. The method according to claim 2, wherein displaying the at least one virtual card in the card area of the virtual scene comprises:
displaying the target virtual card in the at least one virtual card in a first style in a card display area of the virtual scene, the first style being configured for indicating that a card type, to which the target virtual card currently belongs, is the character card; and
controlling the card type, to which the target virtual card currently belongs to, be changed from the character card to the skill card comprises:
updating a display style of the target virtual card from the first style to a second style, the second style being configured for indicating that the card type, to which the target virtual card currently belongs, is changed from the character card to a skill card.

4. The method according to claim 2, wherein controlling the card type, to which the target virtual card currently belongs, to be changed from the character card to the skill card comprises:
controlling the target virtual card to perform a form change, or controlling the target virtual card to perform a card-face flip, wherein
the perform of the form change or the card-face flip is configured for indicating that the card type, to which the target virtual card currently belongs, is changed, and the change of the card type comprises changing from the character card to the skill card.

5. The method according to claim 4, wherein controlling the target virtual card to perform the form change comprises:
controlling, in response to the target virtual character leaving a card frame of the target virtual card, the card frame merge, a card type, to which the target virtual card before merging belongs, being a character card;
as the target virtual character moves toward the target position, adjusting a merging progress of the card frame, so that the merging progress has a negative correlation with a distance between the target virtual character and the target position; and
reorganizing, in response to the target virtual character moving to the target position and being placed at the target position, the merged card frame until the merged card frame is restored to be a target virtual card, a card type, to which the restored target virtual card belongs, being a skill card.

6. The method according to claim 5, further comprising:
when controlling the card frame to merge, displaying a character identifier of the target virtual character in a card face area of the target virtual card, the character identifier being configured for indicating that the card type, to which the target virtual card currently belongs, is a character card; and
displaying, in response to the merged card frame being restored to be the target virtual card, a skill identifier in the card face area, the skill identifier being configured for indicating that the card type, to which the target virtual card currently belongs, is a skill card.

7. The method according to claim 1, further comprising:
when merging the card frame, or when reorganizing the merged card frame, displaying a change special-effect,
the change special-effect being configured for indicating that the card type, to which the target virtual card belongs, is undergoing the change.

8. The method according to claim 1, further comprising:
controlling, in response to that a card restoration condition is satisfied, the card type, to which the target virtual card currently belongs, to be restored from the skill card to the character card, the character card being configured for triggering the character control instruction, and
the card restoration condition comprising at least one of following: the target virtual character being dead, a quantity of times of releasing the target virtual skill reaching a target number, and duration after the card type, to which the target virtual card belongs, being changed from the character card to the skill card reaching target duration.

9. The method according to claim 1, wherein controlling, in response to the character control instruction triggered based on the target virtual card, the target virtual character carried in the target virtual card to move to the target position in the interaction area of the virtual scene comprises:
controlling, in response to a selection operation on a target virtual card, a target virtual character carried in the target virtual card to be in an operable state; and
controlling, in response to a character control instruction triggered for a dragging operation on the target virtual character, the target virtual character to move to a target position indicated by the character control instruction, the target position being a release position of the dragging operation in the interaction area of the virtual scene.

10. The method according to claim 1, further comprising:
displaying placement position indication information in an interaction area of the virtual scene,
the placement position indication information being configured for indicating a placeable position for the target virtual character, to instruct to trigger release of the dragging operation at the placeable position.

11. The method according to claim 1, wherein controlling, in response to the skill release instruction triggered based on the target virtual card, the target virtual character to release the associated target virtual skill comprises:
displaying, in response to a trigger operation on the target virtual card, a skill indicator at an associated position of the target virtual character, the skill indicator being configured for indicating an acting range of the target virtual skill when the target virtual character casts the associated target virtual skill at the associated position;
receiving, in response to that the target virtual card is dragged to the associated position, and the dragging operation on the target virtual card is cast at the associated position, a skill release instruction; and
controlling, in response to the skill release instruction, the target virtual character to release the target virtual skill at the associated position.

12. The method according to claim 1, further comprising:
displaying, in response to a selection operation on the target virtual card, a character control and a skill control,
the character control being configured for triggering the character control instruction, and the skill control being configured for triggering a skill control instruction.

13. The method according to claim 1, further comprising:
displaying, in response to a trigger operation on the target virtual card, at least two candidate virtual skills associated with the target virtual character when there are at least two virtual skills associated with the target virtual character; and
receiving, in response to a selection operation on a target virtual skill, a skill release instruction configured for instructing to release the target virtual skill.

14. The method according to claim 1, wherein controlling the target virtual character to release the associated target virtual skill comprises:
acquiring, when there are at least two virtual skills associated with the target virtual character, an influence parameter configured for influencing a release priority of each virtual skill, the influence parameter comprising at least one of following: an effective acting range corresponding to the release of the virtual skill, and a matching degree between the virtual skill and interaction progress at which the target virtual character is currently located; and
calling, based on the influence parameter, a neural network model to perform release priority prediction processing, to obtain the release priority of each virtual skill; and
controlling the target virtual character to release the target virtual skill with a highest release priority.

15. The method according to claim 1, further comprising:
controlling the target virtual skill associated with the target virtual card to be in a cooling state, and controlling, when cooling is completed, the target virtual skill to be restored from the cooling state to an activated state.

16. The method according to claim 1, further comprising:
controlling, in response to a trigger operation on the target virtual card, the target virtual character to release another associated virtual skill when there are at least two virtual skills associated with the target virtual character, the another associated virtual skill being different from the target virtual skill.

17. An electronic device, comprising:
one or more processors and a memory containing a computer-executable instruction or a computer program that, when being executed, causes the one or more processors to perform:
displaying at least one virtual card in a card area of the virtual scene, the virtual card carrying a virtual character and at least one virtual skill associated with the virtual character;
controlling, in response to a character control instruction triggered based on a target virtual card, a target virtual character carried in the target virtual card to move to a target position in an interaction area of the virtual scene; and
controlling, in response to a skill release instruction triggered based on the target virtual card, the target virtual character to release an associated target virtual skill.

18. The device according to claim 17, wherein the one or more processors are further configured to perform:
receiving, in response to a trigger operation on the target virtual card, the character control instruction when a card type, to which the target virtual card currently belongs, is a character card; and
controlling the card type, to which the target virtual card currently belongs, to be changed from the character card to a skill card, the skill card being configured to trigger the skill release instruction.

19. The device according to claim 18, wherein the one or more processors are further configured to perform:
displaying the target virtual card in the at least one virtual card in a first style in a card display area of the virtual scene, the first style being configured for indicating that a card type, to which the target virtual card currently belongs, is the character card; and
updating a display style of the target virtual card from the first style to a second style, the second style being configured for indicating that the card type, to which the target virtual card currently belongs, is changed from the character card to a skill card.

20. A non-transitory computer-readable storage medium containing a computer-executable instruction or a computer program that, when being executed, causes at least one processor to perform:
displaying at least one virtual card in a card area of the virtual scene, the virtual card carrying a virtual character and at least one virtual skill associated with the virtual character;
controlling, in response to a character control instruction triggered based on a target virtual card, a target virtual character carried in the target virtual card to move to a target position in an interaction area of the virtual scene; and
controlling, in response to a skill release instruction triggered based on the target virtual card, the target virtual character to release an associated target virtual skill.
